(19) United States
(12) Patent Application Publication
(10) Pub. No.: US 2020/0391617 A1
(43) Pub. Date: Dec. 17, 2020

(54) SYSTEM AND METHOD FOR REDUCING DRIVER FATIGUE USING VEHICLE SEAT

(71) Applicants: Hyundai Motor Company, Seoul (KR); Kia Motors Corporation, Seoul (KR); Postech Academy-Industry Foundation, Seoul (KR)

(72) Inventors: Baek Hee Lee, Suwon (KR); Dong Woo Jeong, Hwaseong (KR); Tae Uk Kang, Seoul (KR); Sun Woo Choi, Gwacheon (KR); Hyun Kyu Park, Hwaseong (KR); Seung Young Lee, Bucheon (KR); Sang Do Park, Suwon (KR); Yo Seob Lee, Incheon (KR); Yeong Sik Kim, Seoul (KR); Hee Cheon You, Pohang (KR); Seung Hoon Lee, Gwangyang (KR); Min Jae Kim, Busan (KR); Jeong Bae Ko, Yongin (KR)

(21) Appl. No.: 16/594,644

(22) Filed: Oct. 7, 2019

(30) Foreign Application Priority Data
Jun. 11, 2019 (KR) 10-2019-0068958

(51) Int. Cl. B60N 2/02; B60N 2/20; B60N 2/66

(52) U.S. Cl. CPC B60N 2/0252; B60N 2/20; B60N 2002/026; B60N 2/665; B60N 2/0276; B60N 2/0284

(57) ABSTRACT

A system for reducing driver fatigue in a seat includes an electric reclining device configured to recline a seat back, an electric extension device configured to move an extension unit formed at a front end part of a seat cushion forward and backward, an air cell device including a plurality of air cells installed in the seat back to be expandable, and a controller configured to control driving of the reclining device, the extension device, and the air cell device in a designated driving pattern to implement a driver fatigue reduction posture of the seat.

### CROSS-REFERENCE TO RELATED APPLICATION

This application claims under 35 U.S.C. § 119(a) the benefit of Korean Patent Application No. 10-2019-0068958 filed on Jun. 11, 2019, the entire contents of which are incorporated herein by reference.

### BACKGROUND

### (a) Technical Field

The present disclosure relates to a system and method for reducing driver fatigue using a vehicle seat, more particularly, to the system and method for reducing driver fatigue which allow a seat back and a seat cushion to be moved in a designated pattern so as to reduce driver fatigue.

### (b) Description of the Related Art

When a vehicle is driven for a long time, a driver maintains a posture in which upper and lower parts of the driver's body are almost fixed, and thus, muscular fatigue and eye fatigue may be aggravated and may consequently cause drowsy driving that may result in a serious accident.

In order to solve such a problem, Korean Patent Registration No. 10-1279936 discloses a system for reducing driver fatigue by repeating a reclining operation of a seat back and a tilting operation of a seat cushion in a designated pattern.

However, as exemplarily shown in FIG. 1 (RELATED ART), by a tilting operation of a seat cushion 10 in which a front end part of a seat cushion is raised, a driver's thighs are lifted and the driver's calves are pulled toward the thighs, and thus the driver's foot is temporarily separated apart from an accelerator pedal or a brake pedal 70, which may cause an accident.

### SUMMARY

The present disclosure provides a system and method for reducing driver fatigue using a vehicle seat in which operations of a seat back reclining device, a seat cushion extension device, an air cell device installed in a seat cushion, etc. are combined in a designated pattern so as to allow a driver to take a fatigue reduction posture, such as a driver's entire body stretching or crouching-down posture.

In one aspect, the present disclosure provides a system for reducing driver fatigue in a seat for a vehicle, including an electric reclining device configured to recline a seat back, an electric extension device configured to move an extension unit formed at a front end part of a seat cushion forward and backward, an air cell device including a plurality of air cells installed in the seat back to be expandable, and a controller configured to control driving of the reclining device, the extension device and the air cell device in a designated driving pattern to implement a driver fatigue reduction posture of the seat.

In a preferred embodiment, the air cell device may include a first air cell installed at a lower position of the inside of the seat back to support a driver's waist, a third air cell installed at an upper position of the inside of the seat back to support an upper region of a driver's back, a second air cell installed at a middle position of the inside of the seat back to support a region between the driver's waist and the upper region of the driver's back, and an air blower configured to selectively supply air pressure to implement the driver fatigue reduction posture of the seat to the first to third air cells.

In another preferred embodiment, the controller may be configured to simultaneously output a backward reclining driving signal instructing the reclining device to move the seat back backward and a forward movement driving signal instructing the extension device to move the extension unit forward, as driving signals to implement a driver's entire body stretching posture as the driver fatigue reduction posture of the seat.

In still another preferred embodiment, the controller may be configured to output a driving signal instructing the air blower to supply a maximum amount of air pressure to the first air cell, supply a minimum amount of air pressure to the third air cell and supply an amount of air pressure between the maximum amount and the minimum amount to the second air cell, when the controller outputs driving signals to implement a driver's entire body stretching posture as the driver fatigue reduction posture of the seat.

In yet another preferred embodiment, the controller may be configured to simultaneously output a forward reclining driving signal instructing the reclining device to move the seat back forward and a backward movement driving signal instructing the extension device to move the extension unit backward, as driving signals to implement a driver's entire body crouching-down posture as the driver fatigue reduction posture of the seat.

In still yet another preferred embodiment, the controller may be configured to output a driving signal instructing the air blower to supply a minimum amount of air pressure to the first air cell, supply a maximum amount of air pressure to the third air cell and supply an amount of air pressure between the maximum amount and the minimum amount to the second air cell, when the controller outputs driving signals to implement a driver's entire body crouching-down posture as the driver fatigue reduction posture of the seat.

In another aspect, the present disclosure provides a method for reducing driver fatigue in a seat for a vehicle, including receiving, by a controller, a start signal to implement a driver fatigue reduction posture of the seat, and implementing the driver fatigue reduction posture of the seat, by controlling, by the controller, driving of an electric reclining device configured to recline a seat back, an electric extension device configured to move an extension unit formed at a front end part of a seat cushion forward and backward, and an air cell device including a plurality of air cells installed in the seat back to be expandable in a designated driving pattern.

In a preferred embodiment, the implementing the driver fatigue reduction posture of the seat may include implementing a driver's entire body stretching posture as the driver fatigue reduction posture of the seat by simultaneously outputting, by the controller, a backward reclining driving signal instructing the reclining device to move the seat back backward and a forward movement driving signal instructing the extension device to move the extension unit forward, and implementing a driver's entire body crouching-down posture as the driver fatigue reduction posture of the seat by simultaneously outputting, by the controller, a forward reclining driving signal instructing the reclining device to move the seat back forward and a backward movement driving signal instructing the extension device to move the extension unit backward, and the implementing the driver's entire body stretching posture and the implementing the driver's entire body crouching-down posture may be repeated in designated cycles.

In another preferred embodiment, in the implementing the driver's entire body stretching posture, implementing a driver's upper body stretching posture may be performed by outputting, by the controller, a driving signal instructing an air blower to supply a maximum amount of air pressure to a first air cell, supply a minimum amount of air pressure to a third air cell and supply an amount of air pressure between the maximum amount and the minimum amount to a second air cell.

In still another preferred embodiment, in the implementing the driver's entire body crouching-down posture, implementing a driver's upper body crouching-down posture may be performed by outputting, by the controller, a driving signal instructing the air blower to supply a minimum amount of air pressure to the first air cell, supply a maximum amount of air pressure to the third air cell and supply an amount of air pressure between the maximum amount and the minimum amount to the second air cell.

In yet another preferred embodiment, the method may further include informing the driver of the start signal before the implementing the driver fatigue reduction posture of the seat, when the receiving, by the controller, the start signal driver fatigue reduction posture of the seat is performed.

In still yet another preferred embodiment, the informing the driver of the start signal may be performed by outputting, by the controller, a driving signal instructing the air blower to supply air to a first air cell and a second air cell for 2-3 seconds.

In a further preferred embodiment, the method may further include calculating an optimal forward movement distance of the extension unit using driver's physical condition information, driver's seated posture information, and driver's seated position information before the informing the driver of the start signal, when the receiving, by the controller, the start signal driver fatigue reduction posture of the seat is performed.

In another further preferred embodiment, the optimal forward movement distance of the extension unit of the extension device may be calculated as a forward movement distance of the extension unit before the front surface of the extension unit contacts a driver's poplitei.

In still another further preferred embodiment, the method may further include stopping an operation configured to implement the driver fatigue reduction posture of the seat, when the controller receives information for vehicle driving safety, while the implementing the driver's entire body stretching posture or the driver's entire body crouching-down posture is performed.

In yet another further preferred embodiment, the stopping the operation configured to implement the driver fatigue reduction posture of the seat may be performed when the controller receives at least one of information sensed by a collision sensor, information indicating that a vehicle speed is a designated value or more, or information indicating that a steering wheel change is a designated value or more.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 (RELATED ART) is a view schematically illustrating problems of a conventional system for reducing driver fatigue;

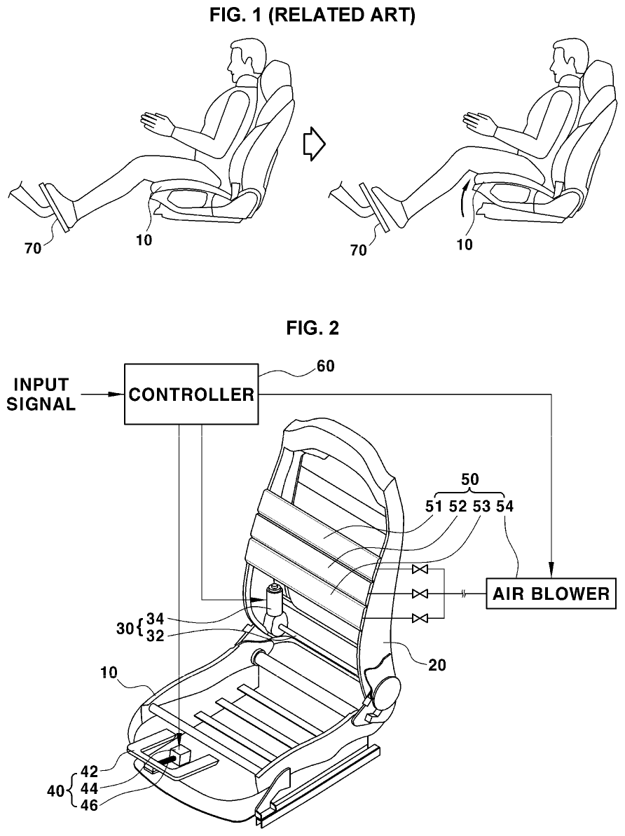

FIG. 2 is a perspective view illustrating a system for reducing driver fatigue in a seat for a vehicle in accordance with the present disclosure;

FIG. 3A is a perspective view illustrating the order of implementation of a driver fatigue reduction posture, by the system for reducing driver fatigue in accordance with the present disclosure;

FIG. 3B is a side view illustrating implementation of the driver fatigue reduction posture, by the system for reducing driver fatigue in accordance with the present disclosure;

FIGS. 4 and 5 are flowcharts representing a method for reducing driver fatigue in a seat for a vehicle in accordance with the present disclosure;

FIG. 6 is a view schematically illustrating problems occurring if an optimal forward movement distance of an extension unit of a seat cushion extension device is not calculated;

FIG. 7 is a view schematically illustrating a method for calculating the optimal forward movement distance of the extension unit in the system for reducing driver fatigue in accordance with the present disclosure; and

FIGS. 8 and 9 are views schematically illustrating methods for estimating a driver's body size, in the method for reducing driver fatigue in accordance with the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter reference will now be made in detail to various embodiments of the present disclosure, examples of which are illustrated in the accompanying drawings and described below. While the disclosure will be described in conjunction with exemplary embodiments, it will be understood that the present description is not intended to limit the disclosure to the exemplary embodiments. On the contrary, the disclosure is intended to cover not only the exemplary embodiments, but also various alternatives, modifications, equivalents and other embodiments within the spirit and scope of the disclosure as defined by the appended claims.

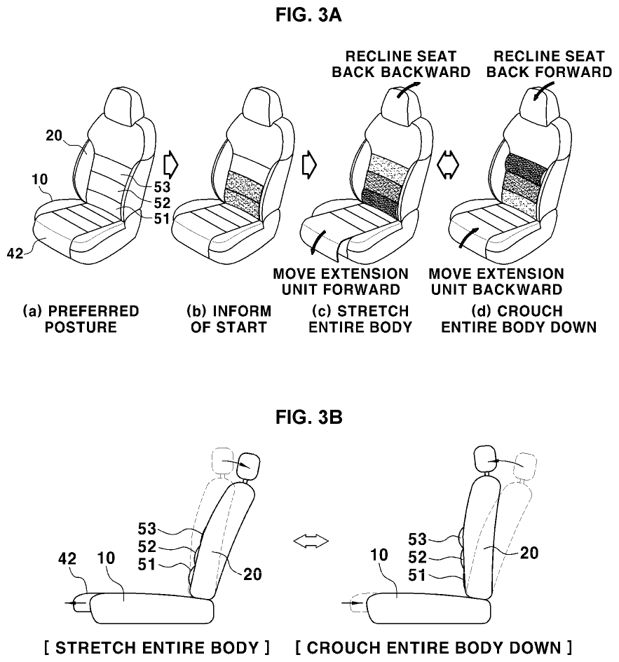

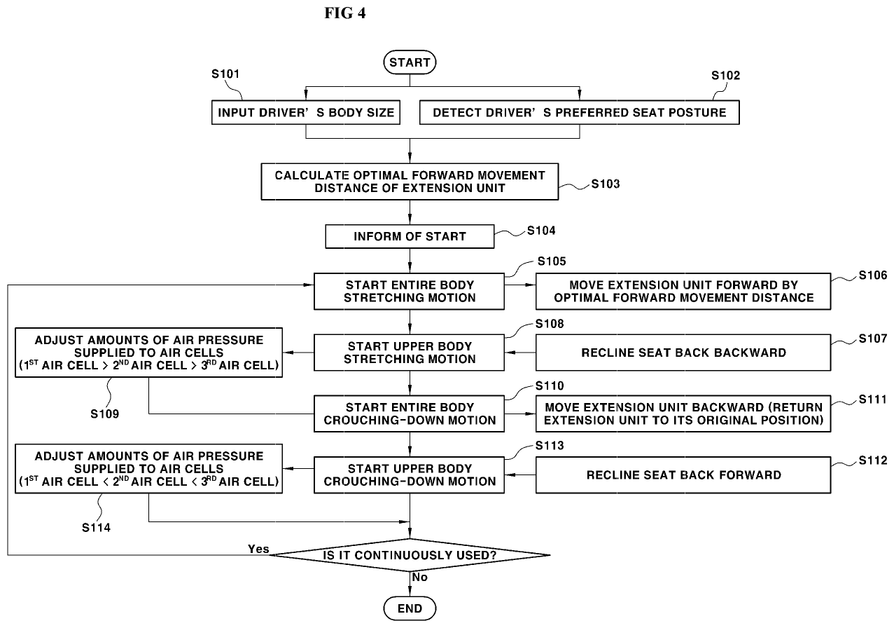

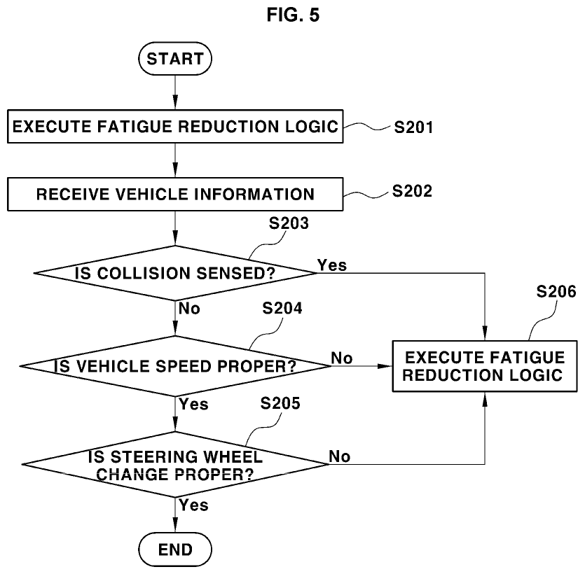

FIG. 2 is a perspective view illustrating a system for reducing driver fatigue in a seat for a vehicle in accordance with the present disclosure, and FIGS. 3A and 3B are perspective and side views illustrating implementation of a driver fatigue reduction posture, by the system for reducing driver fatigue in accordance with the present disclosure.

As exemplarily shown in FIGS. 2 and 3A, a seat for a vehicle includes a seat cushion 10 on which a driver is seated, and a seat back 20 against which the driver leans, and the seat back 20 is reclined forward or backward by an electric reclining device 30.

The electric reclining device 30 includes a rotating shaft 32 mounted at the lower end of the seat back 20 connected to the seat cushion 10, and a reclining motor 34 to output rotation power to the rotating shaft 32, as exemplarily shown in FIG. 2.

Therefore, the rotating shaft 32 is rotated by driving the reclining motor 34, and thus, forward or backward reclining of the seat back 20 is carried out.

An electric extension device 40 to extend a seating area of the seat cushion 10 is mounted at a front end part of the seat cushion 10.

The electric extension device 40, as exemplarily shown in FIG. 2, includes an extension unit 42 mounted at the front end part of the seat cushion 10 to be movable forward and backward, and an extension motor 44 mounted on a frame within the seat cushion 10 to output power to move the extension unit 42 forward and backward, and the extension motor 44 has a lead screw 46 coupled to the extension unit 42 to be turned in place, as an output shaft.

Therefore, the lead screw 46 is turned by driving the extension motor 44, and thus, the extension unit 42 is moved forward and backward.

The air cell device 50 including a plurality of air cells is installed in the seat back 20.

The air cell device 50 includes a first air cell 51 installed at a lower position of the inside of the seat back 20 to support a driver's waist, a third air cell 53 installed at an upper position of the inside of the seat back 20 to support an upper region of a driver's back, a second air cell 52 installed at a middle position of the inside of the seat back 20 to support a region between the driver's waist and the upper region of the driver's back, and an air blower 54 to selectively supply air pressure to implement a driver fatigue reduction posture of the seat to the first to third air cells 51, 52 and 53.

The reclining motor 34 of the reclining device 30, the extension motor 44 of the extension device 40 and the air blower 54 of the air cell device 50 may be driven in a designated driving pattern to implement the driver fatigue reduction posture of the seat by a driving control signal from a controller 60.

When the controller 60 receives a start signal to implement the driver fatigue reduction posture of the seat, the controller 60 repeatedly outputs driving signals to implement a driver's entire body stretching posture as the driver fatigue reduction posture of the seat, and driving signals to implement a driver's entire body crouching-down posture as the driver fatigue reduction posture of the seat in designated cycles.

In particular, the controller 60 is configured to simultaneously output a backward reclining driving signal instructing the reclining motor 34 of the reclining device 30 to move the seat back 20 backward and a forward movement driving signal instructing the extension motor 44 of the extension device 40 to move the extension unit 42 forward, as the driving signals to implement the driver's entire body stretching posture as the driver fatigue reduction posture of the seat, or to simultaneously output a forward reclining driving signal instructing the reclining motor 34 of the reclining device 30 to recline the seat back 20 forward and a backward movement driving signal instructing the extension motor 44 of the extension device 40 to move the extension unit 42 backward, as the driving signals to implement the driver's entire body crouching-down posture as the driver fatigue reduction posture of the seat.

Further, the controller 60 is configured to output a driving signal instructing the air blower 54 to supply the maximum amount of air pressure to the first air cell 51, supply the minimum amount of air pressure to the third air cell 53, and supply an amount of air pressure between the maximum amount and the minimum amount to the second air cell 52, when the controller 60 outputs the driving signals to implement the driver's entire body stretching posture as the driver fatigue reduction posture of the seat.

For example, the air blower 54 supplies air pressure to the first air cell 51 for 6 seconds, supplies air pressure to the third cell 53 for 2 seconds, and supplies air pressure to the second air cell 52 for 4 seconds by the driving signal to implement the driver's entire body stretching posture from the controller 60.

Further, the controller 60 is configured to output a driving signal instructing the air blower 54 to supply the minimum amount of air pressure to the first air cell 51, supply the maximum amount of air pressure to the third air cell 53, and supply an amount of air pressure between the minimum amount and the maximum amount to the second air cell 52, to the air blower 54, when the controller 60 outputs the driving signals to implement the driver's entire body crouching-down posture as the driver fatigue reduction posture of the seat.

For example, the air blower 54 supplies air pressure to the first air cell 51 for 2 seconds, supplies air pressure to the third cell 53 for 6 seconds, and supplies air pressure to the second air cell 52 for 4 seconds by the driving signal to implement the driver's entire body crouching-down posture from the controller 60.

Solenoid valves may be mounted at air supply lines connected between the first to third air cells 51, 52 and 53 and the air blower 54, and air pressure may be selectively supplied to the first to third air cells 51, 52 and 53 by controlling opening and closing of the solenoid valves through a known method.

Here, a process for driving the seat for reducing driver fatigue based on the above-described configuration will be described below.

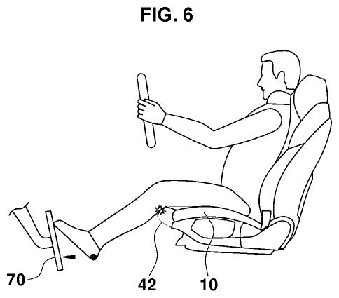

FIGS. 4 and 5 are flowcharts representing a method for reducing driver fatigue in a seat for a vehicle in accordance with the present disclosure.

First, when a driver turns a switch to implement the driver fatigue reduction posture of the seat on (for example, selects a menu to implement the driver fatigue reduction posture from menus of a display mounted around a driver's seat in the vehicle), the controller 60 receives a switch-on signal as a start signal to implement the driver fatigue reduction posture.

Thereafter, a driver directly inputs his/her own physical condition (for example, his/her own height) through an execution screen of a display of an audio, video and navigation (AVN) system (Step S101).

Here, besides direct input of the driver's physical condition through the execution screen of the display of the AVN system by the driver, as a method for discriminating the driver's physical condition, a method for estimating a human body size using a camera or a method for estimating a human body size using a body pressure sensor may be applied.

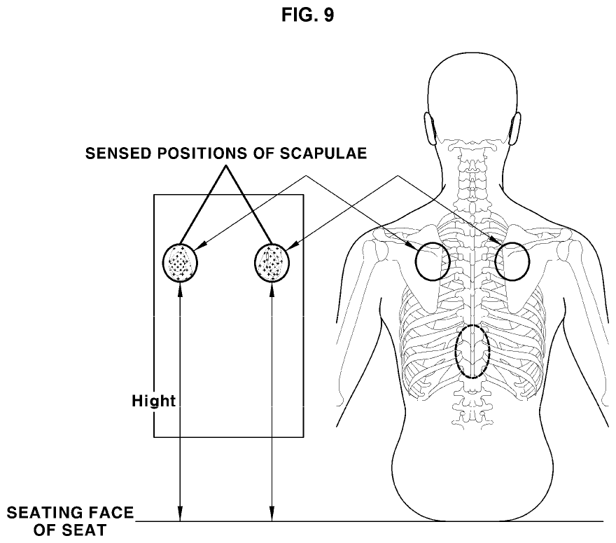

Such a method for estimating a human body size using a camera may include photographing a body size of a person seated on a seat using a camera to acquire an image plane, converting the image plane into a reference plane considering photographing angle and distance, and matching the converted reference plane to a human body size map which is constructed in advance to select the most appropriate human body size, as exemplarily shown in FIG. 8.

Such a method for estimating a human body size using a body pressure sensor may include acquiring pressure information about major body parts (for example, the scapulae) of a person seated on a seat using the body pressure sensor installed in the seat, and estimating a human body size using a height from a seating face of the seat to the body pressure sensor sensed the pressure of the scapulae, as exemplarily shown in FIG. 9.

Thereafter, the controller 60 detects information about a driver's preferred seat posture in addition to information about the driver's physical condition (Step S102), and then calculates an optimal forward movement distance of the extension unit 42 of the extension device 40 (Step S103).

Particularly, the optimal forward movement distance of the extension unit 42 of the extension device 40 is calculated as a forward movement distance of the extension unit 42 before the front surface of the extension unit 42 contacts a driver's poplitei or presses the driver's poplitei.

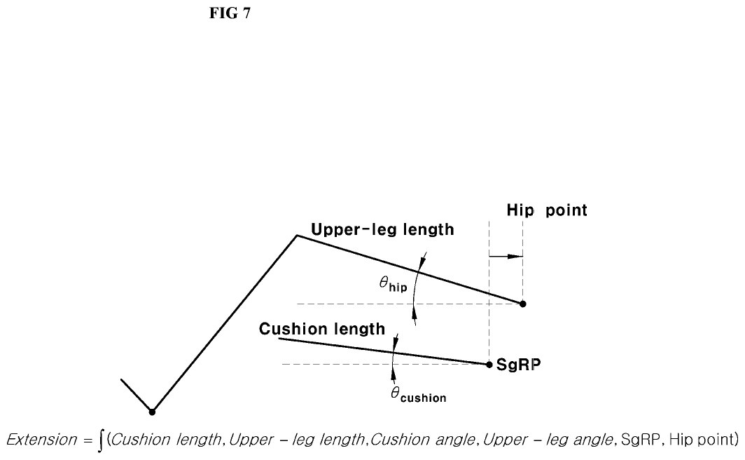

The reason why the optimal forward movement distance of the extension unit 42 is calculated as the forward movement distance of the extension unit 42 before the front surface of the extension unit 42 contacts the driver's poplitei or presses the driver's poplitei is that, when the extension unit 42 is moved forward under the condition that a driver's body condition information and a driver's preferred seat position information are not detected, the extension unit 42 may press the driver's poplitei, as exemplarily shown in FIG. 6, and thereby, a driver's foot may undesirably be close to the accelerator pedal or the brake pedal 70 or undesirably step on the accelerator pedal or the brake pedal 70, i.e., driving safety may be hindered.

Therefore, the controller 60 detects the driver's preferred seat posture information, i.e., information about driver's seated posture and seated position, under the condition that positions of the seat back and the seat cushion are set to form a driver's desired posture (Step S102), in addition to the driver's physical condition information, and then calculates the optimal forward movement distance of the extension unit 42 of the extension device 40 (Step S103).

Here, the optimal forward movement distance of the extension unit 42 may be calculated through a geometric relational expression between the seat cushion and the driver's upper legs.

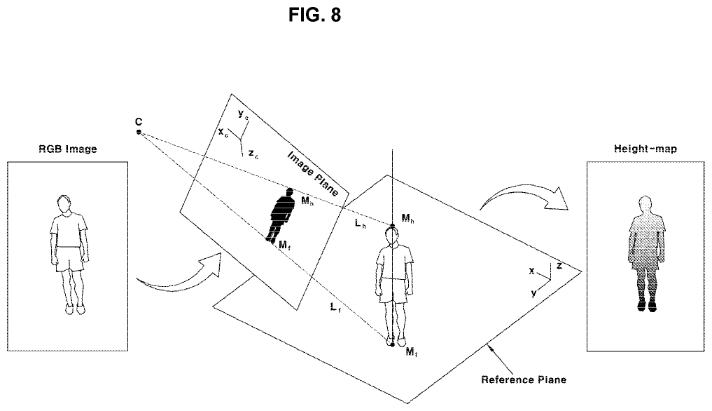

For example, the controller 60 may calculate the optimal forward movement distance of the extension unit 42 based on a geometric relational expression in which an upper leg length varied according to a driver's height and a seat cushion length as the driver's physical condition information, a seat cushion tilting angle and a driver's upper-leg angle as the driver's seated posture information, and a seat cushion rear end point SgRP and a driver's hip point as the driver's seated position information are used as variables, as exemplarily shown in FIG. 7

Further, the above variables regarding the driver's seated posture and seated position information may be acquired from motor driving information (for example, motor RPM information sensed by a Hall sensor, ripple current according to motor driving, etc.) to provide an amount of sliding to restrict a current forward or backward adjusted position of the seat, an amount of height to indicate a current height of the seat cushion, an amount of tilting to indicate a current tilting angle of the seat cushion, an amount of reclining to indicate a current angle of the seat back, etc.

Therefore, the controller 60 informs the driver of the start signal before the controller 60 substantially outputs driving signals to implement the driver fatigue reduction posture of the seat (Step S104).

Particularly, in informing the driver of the start signal (Step S104), the controller 60 outputs a driving signal instructing the air blower 54 to supply air to the first air cell 51 and the second air cell 52 for 2-3 seconds.

Therefore, the driver recognizes that implementation of the driver fatigue reduction posture of the seat is started by pressure of air supplied to the first air cell 51 and the second air cell 52 for 2-3 seconds.

Thereafter, the controller 60 outputs the driving signals to implement the driver fatigue reduction posture of the seat to the reclining motor 34 of the reclining device 30, the extension motor 44 of the extension device 40 and the air blower 54 of the air cell device 50, and thus, implementation of the driver's entire body stretching posture and implementation of the driver's entire body crouching-down posture are repeated in designated cycles, as exemplarily shown in FIG. 3B.

For this purpose, implementation of the driver's entire body stretching posture is first started (Step S105).

In implementation of the driver's entire body stretching posture as the driver fatigue reduction posture of the seat, the controller 60 simultaneously outputs a backward reclining driving signal instructing the reclining motor 34 of the reclining device 30 to recline the seat back 20 backward and a forward movement driving signal instructing the extension device 40 to move the extension unit 42 forward.

Therefore, the extension unit 42 is moved forward by turning of the lead screw 46 caused by driving of the extension motor 44 (Step S106), and simultaneously, the seat back 20 is reclined backward at a designated angle by driving of the reclining motor 34 (Step S107).

Here, the extension unit 42 is moved forward by the optimal forward movement distance (the forward movement distance of the extension unit 42 before the front surface of the extension unit 42 contacts the driver's poplitei or presses the driver's poplitei) calculated in Step S103.

Further, during implementation of the driver's entire body stretching posture, a driver's upper body stretching posture is simultaneously implemented (Step S108).

For this purpose, the controller 60 outputs a driving signal instructing the air blower 54 to supply the maximum amount of air pressure to the first air cell 51 (i.e., to supply air to the first air cell 51 for about 6 seconds), supply the minimum amount of air pressure to the third air cell 53 (i.e., to supply air to the second air cell 52 for about 2 seconds) and supply an amount of air pressure between the maximum amount and the minimum amount to the second air cell 52 (i.e., to supply air to the third air cell 53 for about 4 seconds) (Step S109).

Therefore, as shown in a left portion of FIG. 3B, the driver's entire body stretching posture is implemented by stretching the driver's upper body backward by backward reclining of the seat back 20 and stretching the driver's lower body forward by forward movement of the extension unit 42, and in addition, the driver's upper body stretching posture is implemented by supporting the driver's waist by maximum expansion of the first air cell 51 as if the driver is straightened up, thereby allowing the driver to stretch himself/herself out.

Thereafter, the driver's entire body crouching-down posture is implemented (Step S110).

In implementation of the driver's entire body crouching-down posture, the controller 60 simultaneously outputs a forward reclining driving signal instructing the reclining motor 34 of the reclining device 30 to recline the seat back 20 forward and a backward movement driving signal instructing the extension motor 44 of the extension device 40 to move the extension unit 42 backward.

Therefore, the extension unit 42 is moved backward by turning of the lead screw 46 caused by driving of the extension motor 44 (Step S111), and simultaneously, the seat back 20 is reclined forward at a designated angle by driving of the reclining motor 34 (Step S112).

Further, during implementation of the driver's entire body crouching-down posture, a driver's upper body crouching-down posture is simultaneously implemented (Step S113).

For this purpose, the controller 60 outputs a driving signal instructing the air blower 54 to supply the minimum amount of air pressure to the first air cell 51 (i.e., to supply air to the first air cell 51 for about 2 seconds), supply the maximum amount of air pressure to the third air cell 53 (i.e., to supply air to the second air cell 52 for about 6 seconds) and supply an amount of air pressure between the maximum amount and the minimum amount to the second air cell 52 (i.e., to supply air to the third air cell 53 for about 4 seconds) (Step S114).

Therefore, as shown in a right portion of FIG. 3B, the driver's entire body crouching-down posture is implemented by crouching the driver's upper body forward by forward reclining of the seat back 20 and crouching the driver's lower body backward by backward movement of the extension unit 42, and in addition, the driver's upper body crouching-down posture is implemented by supporting the upper region of the driver's back by maximum expansion of the third air cell 53 as if the driver stoops down, thereby allowing the driver to crouch down.

As described above, since, in order to implement the driver fatigue reduction posture of the seat in accordance with the present disclosure, implementation of the driver's entire body stretching posture including the driver's upper body stretching posture and implementation of the driver's entire body crouching-down posture including the driver's upper body crouching-down posture are repeated in designated cycles, and thus, when driving for a long time, contraction and relaxation of driver's muscles may be performed, and thereby, driver fatigue may be alleviated and wakefulness to prevent drowsy driving may be provided.

During execution of logic to implement the driver's entire body stretching posture or the driver's entire crouching-down posture to implement the driver fatigue reduction posture of the seat in accordance with the present disclosure (Step S201), the controller 60 receives information for vehicle driving safety (Step S202).

Particularly, the controller 60 receives information sensed by a collision sensor, information about a vehicle speed sensed by a vehicle speed sensor or the like, information about a change of a steering wheel sensed by a steering angle sensor, etc., as the information for vehicle driving safety.

Therefore, when the controller 60 receives at least one of the information sensed by the collision sensor, information indicating a vehicle speed of a designated value or more, or information indicating a steering wheel change of a designated value or more, the controller 60 stops execution of the operation to implement the driver fatigue reduction posture of the seat.

That is, when the controller 60 receives the information sensed by the collision sensor (Step S203), the controller 60 stops the logic to implement the driver fatigue reduction posture of the seat, for the purpose of driver safety (Step S206).

Otherwise, when the controller 60 confirms that the current vehicle speed is the designated value or more through the received vehicle speed information (Step S204), the controller 60 stops execution of the logic to implement the driver fatigue reduction posture of the seat, for the purpose of driver safety (Step S206).

Otherwise, when the controller 60 confirms that the current steering wheel change is the designated value or more through the received steering wheel change information (Step S205), the controller 60 stops execution of the logic to implement the driver fatigue reduction posture of the seat, for the purpose of driver safety (Step S206).

As described above, implementation of the driver fatigue reduction posture of the seat in accordance with the present disclosure is carried out within a range within which safe driving is possible, thus promoting safe driving of the vehicle.

As is apparent from the above description, a system and method for reducing driver fatigue in a seat for a vehicle in accordance with the present disclosure provide effects as follows.

First, a reclining operation of a seat back, an extension operation of a seat cushion in which a front end part of the seat cushion is moved forward and backward, an expanding operation of air cells installed in the seat cushion, etc. are combined in a designated pattern so as to implement driver's entire body stretching and crouching-down postures, thus reducing driver fatigue.

Second, as the driver's entire body stretching and crouching-down postures are implemented, contraction and relaxation of driver's muscles may be performed, and thereby, when driving for a long time, driver fatigue may be alleviated and wakefulness to prevent drowsy driving may be provided.

Third, an extension distance of the front end part of the seat cushion is set in consideration of a driver's body type, and may thus prevent the front end part of the seat cushion from pressing the driver's poplitei.

Fourth, the front end part of the seat cushion is moved forward so as not to press the driver's poplitei, thus preventing a driver's foot from undesirably being close to an accelerator pedal or a brake pedal or undesirably being stepped on the accelerator pedal or the brake pedal.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A system for reducing driver fatigue in a seat for a vehicle, comprising:
an electric reclining device configured to recline a seat back;
an electric extension device configured to move an extension unit formed at a front end part of a seat cushion forward and backward;
an air cell device comprising a plurality of air cells installed in the seat back to be expandable; and
a controller configured to control driving of the reclining device, the extension device, and the air cell device in a designated driving pattern to implement a driver fatigue reduction posture of the seat.

2. The system of claim 1, wherein the air cell device comprises:
a first air cell installed at a lower position of an inside of the seat back to support a driver's waist;
a third air cell installed at an upper position of the inside of the seat back to support an upper region of a driver's back;
a second air cell installed at a middle position of the inside of the seat back to support a region between the driver's waist and the upper region of the driver's back; and
an air blower configured to selectively supply air pressure to implement the driver fatigue reduction posture of the seat to the first to third air cells.

3. The system of claim 1, wherein the controller is configured to simultaneously output a backward reclining driving signal instructing the reclining device to move the seat back backward and a forward movement driving signal instructing the extension device to move the extension unit forward, as driving signals to implement a driver's entire body stretching posture as the driver fatigue reduction posture of the seat.

4. The system of claim 2, wherein the controller is configured to output a driving signal instructing the air blower to supply a maximum amount of air pressure to the first air cell, supply a minimum amount of air pressure to the third air cell, and supply an amount of air pressure between the maximum amount and the minimum amount to the second air cell, when the controller outputs driving signals to implement a driver's entire body stretching posture as the driver fatigue reduction posture of the seat.

5. The system of claim 1, wherein the controller is configured to simultaneously output a forward reclining driving signal instructing the reclining device to move the seat back forward and a backward movement driving signal instructing the extension device to move the extension unit backward, as driving signals to implement a driver's entire body crouching-down posture as the driver fatigue reduction posture of the seat.

6. The system of claim 2, wherein the controller is configured to output a driving signal instructing the air blower to supply a minimum amount of air pressure to the first air cell, supply a maximum amount of air pressure to the third air cell, and supply an amount of air pressure between the maximum amount and the minimum amount to the second air cell, when the controller outputs driving signals to implement a driver's entire body crouching-down posture as the driver fatigue reduction posture of the seat.

7. A method for reducing driver fatigue in a seat for a vehicle, comprising:
receiving, by a controller, a start signal to implement a driver fatigue reduction posture of the seat; and
implementing the driver fatigue reduction posture of the seat, by controlling, by the controller, driving of an electric reclining device configured to recline a seat back, an electric extension device configured to move an extension unit formed at a front end part of a seat cushion forward and backward, and an air cell device comprising a plurality of air cells installed in the seat back to be expandable in a designated driving pattern.

8. The method of claim 7, wherein implementing the driver fatigue reduction posture of the seat comprises:
implementing a driver's entire body stretching posture as the driver fatigue reduction posture of the seat by simultaneously outputting, by the controller, a backward reclining driving signal instructing the reclining device to move the seat back backward and a forward movement driving signal instructing the extension device to move the extension unit forward; and
implementing a driver's entire body crouching-down posture as the driver fatigue reduction posture of the seat by simultaneously outputting, by the controller, a forward reclining driving signal instructing the reclining device to move the seat back forward and a backward movement driving signal instructing the extension device to move the extension unit backward,
wherein implementing the driver's entire body stretching posture and the implementing the driver's entire body crouching-down posture are repeated in designated cycles.

9. The method of claim 8, wherein, in implementing the driver's entire body stretching posture, implementing a driver's upper body stretching posture is performed by outputting, by the controller, a driving signal instructing an air blower to supply a maximum amount of air pressure to a first air cell, supply a minimum amount of air pressure to a third air cell, and supply an amount of air pressure between the maximum amount and the minimum amount to a second air cell.

10. The method of claim 8, wherein, in the implementing the driver's entire body crouching-down posture, implementing a driver's upper body crouching-down posture is performed by outputting, by the controller, a driving signal instructing an air blower to supply a minimum amount of air pressure to a first air cell, supply a maximum amount of air pressure to a third air cell, and supply an amount of air pressure between the maximum amount and the minimum amount to a second air cell.

11. The method of claim 7, further comprising informing the driver of the start signal before implementing the driver fatigue reduction posture of the seat, when the receiving, by the controller, the start signal driver fatigue reduction posture of the seat is performed.

12. The method of claim 11, wherein the informing the driver of the start signal is performed by outputting, by the controller, a driving signal instructing the air blower to supply air to a first air cell and a second air cell for 2-3 seconds.

13. The method of claim 11, further comprising calculating an optimal forward movement distance of the extension unit using a driver's physical condition information, a driver's seated posture information, and a driver's seated position information before the informing the driver of the start signal, when the receiving, by the controller, the start signal driver fatigue reduction posture of the seat is performed.

14. The method of claim 13, wherein the driver's physical condition information is acquired by one of a method for directly inputting, by the driver, his/her own physical condition through an execution screen of a display of an AVN system, a method for estimating a driver's body size using a camera by matching a body size of the driver seated on the seat, photographed by the camera, to a human body size map constructed in advance and then selecting an appropriate human body size, and a method for estimating a driver's body size using a body pressure sensor by acquiring body pressure information of the driver seated on the seat, measured by the body pressure sensor installed in the seat.

15. The method of claim 13, wherein the driver's seated posture information and the driver's seated position information are acquired from motor driving information configured to provide an amount of sliding to restrict a current forward or backward adjusted position of the seat, an amount of height to indicate a current height of the seat cushion, an amount of tilting to indicate a current tilting angle of the seat cushion, and an amount of reclining to indicate a current angle of the seat back.

16. The method of claim 13, wherein the optimal forward movement distance of the extension unit of the extension device is calculated as a forward movement distance of the extension unit before the front surface of the extension unit contacts a driver's poplitei.

17. The method of claim 8, further comprising stopping an operation configured to implement the driver fatigue reduction posture of the seat, when the controller receives information for vehicle driving safety, while the implementing the driver's entire body stretching posture or the driver's entire body crouching-down posture is performed.

18. The method of claim 17, wherein the stopping the operation configured to implement the driver fatigue reduction posture of the seat is performed when the controller receives at least one of information sensed by a collision sensor, information indicating that a vehicle speed is a designated value or more, or information indicating that a steering wheel change is a designated value or more.
